(19) United States
(12) Patent Application Publication
(10) Pub. No.: US 2004/0213935 A1
(43) Pub. Date: Oct. 28, 2004

(54) Protected plastic tube and method for making same

(76) Inventors: Claude Dehennau, Warerloo (BE); Pierre Matz, Nil Saint-Vincent (BE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/475,098

(22) PCT Filed: Apr. 25, 2002
(86) PCT No.: PCT/EP02/04669

(30) Foreign Application Priority Data
Apr. 27, 2001 (BE) 2001/0292

(51) Int. Cl. B32B 1/08

(52) U.S. Cl. 428/36.91

(57) ABSTRACT

Multilayer plastic pipe and its manufacturing process, the pipe being protected from deterioration of its properties, when being used and when being handled, and formed from a tubular polymeric support protected by two protective layers each comprising a polymeric composition of unoriented structure, the first layer being compatible with the polymeric composition of the subjacent plastic and the second being an external layer, also serving as finishing coat. A reinforcing layer formed from tapes comprising an oriented polymeric composition may be inserted between the support and the first protective layer.

The present invention relates to a multilayer plastic pipe protected from deterioration of its properties when being used and when being handled.

Pipes that have to withstand high mechanical stresses, such as large-diameter pipes and/or pipes subjected to high internal pressure, can be economically produced from ductile cast iron. However, plastic pipes are, in a number of cases, preferred to cast iron because they are much lighter and they exhibit remarkable corrosion resistance.

In order to withstand high mechanical stresses as well as cast iron does, conventional plastic pipes must have a greater wall thickness, which increases their cost and makes them less competitive compared with ductile cast iron pipes.

Moreover, plastic pipes often have a low creep resistance under prolonged stress. However, it is very important, in the case of certain types of use, for the strength of these pipes, for example the burst strength, not to degrade after a long period of use, which may sometimes extend to several decades.

Several approaches have been envisaged for solving this problem. The first approach consisted in producing pipes whose plastic is biaxially oriented in the directions parallel and perpendicular to the axis of the pipe. However, the biaxial orientation operation can be carried out only on the pipe preformed by extrusion, making the process a batch process and increasing the cost thereof Moreover, to maintain the biaxial orientation of the material during the fitting of couplers means that particular precautions, involving the use of many special couplers, have to be taken. Moreover, the reinforcement obtained using this technique is most particularly effective in the longitudinal direction, but only very partially solves the problem of resistance to the radial forces that represent the maximum stresses in some applications, for example the transportation of pressurized fluids. Hitherto, the endeavours to make the biaxial orientation process continuous have not yet fully borne fruit because of the technological constraints and the substantial cost burden that they entail, compared with the still insufficient increase in strength obtained.

Another approach has been to place reinforcements on plastic pipes, such as for example a continuous winding of fibres (for example glass fibres) impregnated with a thermoplastic or thermosetting resin (COFITS). However, this approach is not without drawbacks either, as these windings are generally brittle and greatly increase the density of the resulting reinforced pipe and its cost. Moreover, the effectiveness of these reinforcements does not always remain constant over time and it is often difficult to recycle the pipe at the end of life, because of the incorporation into the polymer of the pipe of foreign matter difficult to separate.

Also known is U.S. Pat. No. 4,093,004 which discloses the principle of reinforcing supports made of various materials (board, paper, rubber, wood or plastic) by means of oriented polyolefin tapes. However, the reinforced pipe obtained does not have sufficient resistance in environments comprising organic solvents, such as those found for example in the adhesive compositions used to fasten couplers to the pipe. In addition, time spent by the pipe at high temperature is detrimental to preservation of the orientation of the reinforcing tapes and, consequently, detrimental to the persistence of the good mechanical strength of the pipe.

The object of the invention is to solve the problems posed by the abovementioned known reinforcing systems, while maintaining the production cost within limits that are acceptable and competitive with ductile cast iron pipes.

For this purpose, the invention relates to a multilayer plastic pipe protected from deterioration of its properties, when being used and when being handled, and formed from a tubular support based on a polymeric composition whereby the pipe is protected by two layers each comprising an unoriented polymeric composition, the first being compatible with the polymeric composition of the subjacent plastic and the second being an external layer, also serving as finishing coat.

The invention relates to a multilayer pipe, that is to say a pipe formed from a tubular support covered with at least the protective layers, the outermost layer of which forms a continuous surface layer.

The tubular support is a hollow object in the form of a tube. It consists, at least partly, of a polymeric composition.

The term “polymeric composition” is understood to mean any material comprising at least one plastic based on a polymer made of synthetic resin.

All types of plastic may be suitable. Plastics that are very suitable fall within the thermoplastics category.

The term “thermoplastic” denotes any thermoplastic polymer, including thermoplastic elastomers, and blends thereof The term “polymer” denotes both homopolymers and copolymers (especially binary or ternary copolymers). Examples of such copolymers are, in a non-limiting manner: random copolymers, block copolymers and graft copolymers.

Any type of thermoplastic polymer or copolymer whose melting point is below the decomposition temperature is suitable. Synthetic thermoplastics that have a melting range spread over at least 10 degrees Celsius are particularly suitable. Examples of such materials include those that exhibit polydispersity in their molecular weight.

In particular, polyolefins, polyvinyl halides, thermoplastic polyesters, polyketones, polyamides and copolymers thereof may be used. A blend of polymers or copolymers may also be used, as may a blend of polymeric materials with inorganic, organic and/or natural fillers such as, for example, but non-limitingly, carbon, salts and other inorganic derivatives, glass fibres, natural mineral fibres or polymeric fibres. It is also possible to use multilayer structures consisting of stacked layers bonded together, comprising at least one of the polymers or copolymers described above.

Polymers often employed are polyvinyl chloride and high-density polyethylene. Excellent results have been obtained with polyvinyl chloride.

The expression “protected from deterioration” is understood to mean a pipe whose strength capability under its environmental conditions is enhanced by envelopment of the pipe with at least one layer of material especially suitable for withstanding these conditions.

As an example of environmental conditions that may be deleterious to the retention of the properties of the unprotected pipes, mention may be made of high temperature and the presence of organic solvents.

The protective layers are specifically the special layers mentioned above that increase the strength capability of the pipe under its environmental conditions.

These protective layers each comprise a polymeric composition of unoriented structure, that is to say a composition comprising, as polymers, only those whose molecular chains do not have any particular orientation.

According to the invention, the first protective layer is compatible with the polymeric composition of the subjacent plastic. The term “compatible” means that the polymeric composition of which the protective layer is composed, is inert from the chemical standpoint vis-a-vis the subjacent plastic and the physical composition of which protective layer is such that, in the melt state, it may easily blend into this subjacent plastic without giving rise to segregation phenomena. The compatibility may also imply easy adhesion of one layer to the other.

Examples of polymeric compositions suitable for the first protective layer are those comprising polyvinyl halides and polyolefins. Polyvinyl chloride has given excellent results.

The second protective layer is a finishing coat, that is to say an external layer that fixes the external dimensions of the pipe and the nature and finish of its surface. The second protective layer may have a composition identical to or different from that of the first layer. In particular, it may be made of the same polymeric material as that of the first layer. Polyvinyl chloride has also given good results in the composition of this second protective layer.

According to a first particular embodiment of the pipe according to the invention, the support comprises a polymeric composition of biaxially oriented structure.

The term “biaxially oriented” is understood to mean a polymeric structure in which at least 20% by weight of the molecular chains of the polymers that are involved in its composition are arranged in two different directions. Preferably, the two directions are mutually perpendicular. Any type of thermoplastic polymer that lends itself easily to its molecular chains being oriented may be chosen for polymers with oriented chains. Examples of such polymers are polyolefins, polyvinyl halides, polyamides and copolymers thereof.

When the support does not comprise an oriented polymeric composition, a second advantageous variant of the pipe according to the invention is the one in which a reinforcing layer consisting of at least two thicknesses of reinforcing tapes comprising an oriented polymeric composition is placed between the support and the first protective layer. According to this second variant of the invention, it is the oriented character of the polymeric composition of the reinforcing tapes that provides the pipe with effective reinforcement.

The term “reinforced pipe” is understood to mean a pipe in which the intrinsic mechanical properties of the base material composition of which the pipe is composed are modified by the presence of an additional material composition that differs from this base material and, by its presence, increases the mechanical strength. The base material composition is a polymeric composition that represents at least 40% by weight of the total weight of the reinforced pipe. The base polymeric composition is that found in the support. The additional material composition is formed by the composition of the reinforcing layer.

The expression “oriented polymeric composition” means in this case that the polymeric composition comprises at least one oriented polymer.

The reinforcing layer may comprise a single oriented polymeric composition. Alternatively, it may also comprise a blend of several polymeric compositions and optionally of non-polymeric additives, at least one of the polymers of which is oriented. The polymer may be any thermoplastic polymer that can be present in the tapes in oriented form, that is to say having at least 20% by weight of its constituent molecular chains lying in the same direction. Preferably, the direction of orientation is that of the length of the tape. Any type of thermoplastic polymer lending itself well to its molecular chains being oriented may be chosen for the oriented polymer. In general, an oriented polymer whose nature is the same as that of the polymers commonly used for producing pipes that have to withstand pressure is used. Advantageous examples of such polymers in the case of a support made of high-density polyethylene (HDPE) are, non-limitingly, multimodal HDPE resins and crosslinkable resins.

The two thicknesses of reinforcing tapes are wound around the support in such a way that the second thickness completely covers the first around the support.

When the pipe is reinforced by oriented tapes, an advantageous alternative to the second variant described above consists in the first thickness of tapes of the reinforcing layer being adhesively bonded to the support, that is to say fastened to the latter by means of an adhesive of the usual suitable kind.

It is also particularly beneficial for the various thicknesses of the reinforcing layer to be furthermore bonded to one another so as to give the entire pipe maximum cohesion.

In all the situations indicated above, an advantageous embodiment of the pipe is for its first protective layer to be formed by at least one thickness of unoriented tapes wound around the pipe.

Among the pipe variants described above, one particularly advantageous embodiment is the one in which the first protective layer is bonded to the subjacent polymeric composition.

The invention also relates to a process for producing a multilayer plastic pipe protected from deterioration of its properties when being used and when being handled, in which:

a) the first protective layer is applied to a tubular support based on a polymeric composition by winding at least one thickness of tapes of unoriented polymeric composition compatible with the polymeric composition of the subjacent plastic; and

b) the second protective layer, comprising an unoriented polymeric composition is then applied by overextrusion, forming the external finishing coat.

The particular terms defined above in the case of the pipe according to the invention have the same meaning here in respect of the process..

The second protective coating may be applied by overextrusion using any overextrusion technique well known per se, in particular the overextrusion techniques used in the plastic pipe manufacturing industry. An example of these techniques is the use of a hollow ring-shaped die through the middle of which the pipe passes, the said die allowing a controlled amount of polymeric composition to be uniformly and continuously deposited around the periphery of the pipe.

An advantageous variant of the process according to the invention for obtaining a pipe that is reinforced and protected from mechanical stresses consists in carrying out the following operations:

a) firstly, a reinforcing layer formed from at least two thicknesses of tapes comprising an oriented polymeric composition is applied, to a support comprising a polymeric composition of unoriented structure, by winding tapes in such a way that the tapes of one particular thickness make, with those of the adjacent thickness, a similar angle, but of opposite sign, relative to the axis of the pipe;

b) the first protective layer is then applied; and

c) lastly, the external finishing coat is applied.

In this definition, the expression “similar angle” means an angle at least equal to the same angle less 5 degrees of angle. The expression “similar angle” also includes an angle at most equal to the same angle plus 5 degrees of angle. Preferably, this expression means an angle at least equal to the same angle less 2 degrees of angle. Also preferably, it includes an angle at most equal to the same angle plus 2 degrees of angle.

The application of the two protective layers is carried out in the same way as that explained above in the case of the manufacture of the unreinforced pipe.

In the variant of the process for manufacturing a protected and reinforced pipe, it is furthermore particularly beneficial to precoat the reinforcing tapes with adhesive. In this case, it may be advantageous to use a polymer adhesive that is thermally activated after being applied, by carrying out the following operations, in order:

a) the tapes of the reinforcing layer are precoated with the thermally activated polymer adhesive;

b) these reinforcing tapes are applied by winding them around the support;

c) the first protective layer is applied;

d) the adhesive of the reinforcing layer is activated by irradiation of the pipe with infrared radiation while the pipe is being formed; and

e) the external finishing coat is applied.

The precoating operation may be carried out immediately before application of the reinforcing tapes, or else at a later time, at another moment before manufacture of the pipe. Likewise, the operation may be performed on one side of the tapes, or on both. Preferably, it is performed on one of the sides.

This technique advantageously makes it possible to apply the reinforcing tapes without heating them beforehand and then to easily control the flow of heat radiated by the infrared radiation through the first protective layer so that it does not destroy the orientation of the polymeric composition of the reinforcing tapes.

As a variant, the adhesive of the reinforcing tapes may also be activated in several separate steps, after each application of a thickness of tapes, by successive irradiations of the pipe with infrared radiation while the pipe is being formed.

It is also possible to activate this adhesive in several separate steps after a group of several successive thicknesses of reinforcing tapes has been applied.

At least one of the protective layers may, as a variant, also be bonded to the subjacent structure by means of an adhesive. This adhesive may, for example, be activated by infrared irradiation.

The example that follows is given the purpose of illustrating the invention without wishing in any way to limit its scope.

A 360 mm wide tape of oriented polyvinyl chloride (PVC) was produced by drawing a 400 mm film of unoriented SOLVIN® 266RC PVC with a draw ratio of 400% by means of a laboratory calender. After drawing, this tape had a thickness of 400 μm, an elastic modulus of 5 GPa and a tensile strength of 175 MPa.

Next, this strip was coated on one side only with a heat-activated water-soluble polymer adhesive of the LUPHEN®D200A brand.

The coated tape was wound around a pipe made of POLVA® PVC having an outside diameter of 50 mm, an outside diameter/wall thickness ratio of 34 and of ordinary quality from the standpoint of its pressure resistance (nominal acceptable pressure of 0.75 MPa). The winding was carried out so as to form two layers each crossed at an angle of 55° to the axis of the tube. The outer surface of the tapes wound around the pipe was then heated to 75° C. for 5 seconds.

The pipe obtained was then covered with a further layer of SOLVIN® 266RC PVC, to which additives had been added beforehand, in the form of a 400 μm thick unoriented tape completely covering it and precoated with the LUPHEN®D200A adhesive. The additives comprised a mixture of a carboxylate-type tin stabilizer (3% by weight relative to the PVC), a processing aid (1% by weight of polymethyl methacrylate) and a lubricant (1% by weight) composed of a mixture of calcium stearate, paraffin wax and oxydized polyethylene wax. The adhesive was then activated under the same conditions as those described above in the case of the oriented tapes.

The tube obtained was then covered with a finishing coat made of SOLVIN® 266RC PVC (a grade usually employed for pipes 300 μm in thickness), to which the same additives as those described above were added, by passing the pipe through an annular die, then through a sizing device and into a cooling tank filled with water at room temperature.

The burst pressure measurements carried out according to the ISO 9080 standard on a control pipe, made of POLVA® PVC, neither protected nor reinforced, and consequently not according to the invention, and on pipes reinforced and protected according to the invention gave the following results:

| Type of pipe | Thickness (mm) | Burst pressure (bar) |
|---|---|---|
| POLVA ® | 3.7 | 85 |
| Protected and reinforced | 3.2 | 100 |
| POLVA ® | | |
| Protected and reinforced | 3.8 | 120 |
| POLVA ® | | |

It may be seen that the pipes according to the invention have a substantially better burst pressure than an unreinforced pipe. It is even possible to save about 25% by weight of material relative to a conventional pipe, while nevertheless increasing the burst strength by 15% (reinforced and protected POLVA® pipe 3.2 mm thick).

1-11. (Canceled).

12. A multilayer plastic pipe protected from deterioration of its properties, when being used and when being handled, and formed from a tubular support based on a polymeric composition, said plastic pipe being protected by two layers each comprising an unoriented polymeric composition, the first being compatible with the polymeric composition of the subjacent plastic and the second being an external layer, also serving as finishing coat.

13. The pipe according to claim 12, reinforced against mechanical stresses, wherein the support comprises a polymeric composition of biaxially oriented structure.

14. The pipe according to claim 12, reinforced against mechanical stresses, wherein the support comprises a polymeric composition of unoriented structure and wherein a reinforcing layer formed from at least two thicknesses of reinforcing tapes comprising an oriented polymeric composition is placed between the support and the first protective layer.

15. The pipe according to claim 14, wherein the first thickness of the reinforcing layer is adhesively bonded to the support.

16. The pipe according to claim 14, wherein the various thicknesses of the reinforcing layer are bonded to one another.

17. The pipe according to claim 12, wherein the first protective layer is formed from at least one thickness of tapes wound around the pipe.

18. The pipe according to claim 12, wherein the first protective layer is bonded to the subjacent polymeric composition.

19. A process for producing a multilayer plastic pipe protected from deterioration of its properties when being used and when being handled, wherein:
a) a first protective layer is applied to a tubular support based on a polymeric composition by winding at least one thickness of tapes of unoriented polymeric composition compatible with the polymeric composition of the subjacent plastic; and
b) a second protective layer comprising an unoriented polymeric composition is then applied by overextrusion, forming the external finishing coat.

20. The process according to claim 19, for the production of a pipe reinforced against mechanical stresses wherein:
a) firstly, a reinforcing layer formed from at least two thicknesses of tapes based on an oriented polymeric composition is applied to a support based on an unoriented polymeric composition, by winding tapes in such a way that the tapes of one particular thickness make, with those of the adjacent thickness, a similar angle, but of opposite sign, relative to the axis of the pipe;
b) the first protective layer is then applied; and
c) lastly, the external finishing coat is applied.

21. The process according to claim 20, wherein the following operations are carried out, in order:
a) the tapes of the reinforcing layer are precoated on one of their sides with a thermally activated polymer adhesive;
b) these reinforcing tapes are applied by winding them around the support;
c) the first protective layer is applied;
d) the adhesive of the reinforcing layer is activated by irradiation of the pipe with infrared radiation while the pipe is being formed; and
e) the external finishing coat is applied.

22. The process according to claim 20, wherein the following operations are carried out, in order:
a) the tapes of the reinforcing layer are precoated with a thermally activated polymer adhesive;
b) these reinforcing tapes are applied by the winding, around the support, of each of the successive tape thicknesses while at the same time the precoated adhesive is activated in several separate steps, after each application of a thickness of tapes or of a group of several successive thicknesses of these tapes, by successively irradiating the pipe with infrared radiation while the pipe is being formed;
c) the first protective layer is applied; and
d) the external finishing coat is applied.
